(19) United States
(12) Patent Application Publication
(10) Pub. No.: US 2026/0022055 A1
(43) Pub. Date: Jan. 22, 2026

(54) STRENGTHENED MICROCRYSTALLINE GLASS, PREPARATION METHOD THEREFOR, AND USE THEREOF

(71) Applicants: Chongqing Aureavia Hi-tech Glass Co., Ltd., Chongqing (CN); Huawei Technologies Co., LTD., Shenzhen (CN)

(72) Inventors: Hao HUANG, Chongqing (CN); Guangyu LU, Chongqing (CN); Jingpeng ZHOU, Chongqing (CN); Qian TIAN, Chongqing (CN); Jiejie CHEN, Shenzhen (CN); Guangxiang ZHU, Shenzhen (CN); Yihong HUANG, Shenzhen (CN)

(21) Appl. No.: 18/994,990

(22) PCT Filed: Jul. 13, 2023
(86) PCT No.: PCT/CN2023/107103

§ 371 Date: Jan. 15, 2025

(30) Foreign Application Priority Data
Jul. 22, 2022 (CN) 202210869057.X

(51) Int. Cl. C03C 10/00; C03C 21/00

(52) U.S. Cl. CPC C03C 10/0027; C03C 10/0054; C03C 21/002

(57) ABSTRACT

Provided in the present application are a strengthened microcrystalline glass, a preparation method therefor, and the use thereof. The strengthened microcrystalline glass comprises a petalite crystal phase and a lithium disilicate crystal phase. The strengthened microcrystalline glass has a compressive stress layer, which is formed by chemical strengthening, on the surface and has a tensile stress layer on the inside. The strengthened microcrystalline glass satisfies: (CS_50/DOL_0)≥0.332×(surface CS/|CT_CV|); DOL_0≥0.187t; 1.01%≥Δα≥0.65%; and Δα=5×10⁻⁵×|CT_AV|+0.0026. Under the condition of 80-mesh abrasive paper, the average height of drop failure of the strengthened microcrystalline glass can reach 1.30-1.80 m. Compared with the prior art, the strengthened microcrystalline glass of the present application has remarkable improvement in drop resistance on rough ground, and therefore can be used as a material for protection cover plates of smart terminal products, such as mobile phones.

### RELATED APPLICATION

This application claims the priority to the prior application document No. CN202210869057.X filed before the China National Intellectual Property Administration on Jul. 22, 2022, which is incorporated herein in its entirety.

### TECHNICAL FIELD

The present application relates to the field of lithium-aluminum-silica glass-ceramic, and in particular, to a glass-ceramic with excellent drop resistance and a preparation method thereof.

### BACKGROUND

With the advent of the smart era of a mobile phone, the mobile phones have become an indispensable communication tool in daily life. As the number of mobile phone users is increasing year by year, in order to meet the requirements of mobile phone users and increase their experience, the speed of updating, transformation and elimination of mobile phones is also increasing. With the gradual thinning of mobile phones, the performance requirements of their cover glass are gradually improved. Among them, a glass-ceramic with petalite and lithium disilicate as a main crystalline phase can achieve a crystallinity of more than 70 wt %, and the transmittance in the optical band of 360 nm to 740 nm is close to that of the commonly used lithium-aluminum-silica glass. It can also be chemically strengthened in a salt bath to further improve its mechanical properties such as drop resistance and impact resistance. Therefore, it stands out and has attracted wide attention in the cover glass industry.

The reason why the cover glass is broken during use is usually caused by the collision between the cover glass and sharp objects (such as fine sand, cement, and pebbles) due to dropping from a height. A glass surface is partially damaged, and a micro-crack is formed at a damage point, and the crack extend from the glass surface to internal expansion. When the crack extend through a depth of a compressive stress layer on the glass surface and reach a tensile stress layer, the crack will rapidly expand in a tensile stress zone, making the crack penetrate the whole glass, thus resulting in breakage and fracture of the glass.

The existing patented glass-ceramic with petalite and lithium disilicate as a main crystalline phase, which mainly inhibits crack propagation by improving CT and DOL_0 after strengthening to improve a damage resistance of the glass.

CN201980020541.1 discloses that an absolute value of the maximum compressive stress on a surface is 1.8 to 2.2 times of the absolute value of the maximum central tensile stress obtained by a specific strengthening method, and a maximum CT value reaches 140 MPa.

CN202010348413.4 discloses that through two-step mixed salt strengthening, a maximum CT value reaches 120 MPa, DOL_0≥100 μm, and a maximum linear density of tensile stress reaches 50000 MPa/mm.

### SUMMARY

It is regrettable that the drop resistance of such glass is still inadequate, making it challenging to meet the performance requirements of high-end mobile phones at present.

In view of the problem that the drop resistance of the glass-ceramic in the prior art cannot meet the demand, the inventors, after much research, provide a glass-ceramic with more excellent drop resistance, the drop resistance of which is significantly improved compared to the prior art. Specifically, the present application provides the following technical solutions.

1. A strengthened glass-ceramic, comprising a petalite crystalline phase and a lithium disilicate crystalline phase, and the strengthened glass-ceramic has a compressive stress layer formed by chemical strengthening on a surface and a tensile stress layer inside; and
in the strengthened glass-ceramic:
DOL_0≥0.187 t, t is a thickness of the strengthened glass-ceramic;

$$1.01 \% \geq Δα \geq 0.65 \% , Δα = 5 \times {10}^{- 5} \times \vert CT\_AV \vert + 0.0026 ;$$

$$( CS\_ 50 / DOL\_ 0 ) \geq 0.332 \times ( surface CS / \vert CT\_CV \vert ) ;$$

wherein:
surface CS: surface compressive stress, measured in MPa;
CS_50: compressive stress at a depth of 50 μm from a glass surface, measured in MPa;
CT_AV: average tensile stress in the tensile stress layer, measured in MPa;
CT_CV: maximum tensile stress in the tensile stress layer, measured in MPa; and
DOL_0: a depth of the compressive stress layer, measured in μm.

2. The strengthened glass-ceramic according to technical solution 1, wherein the tensile stress layer of the strengthened glass-ceramic comprises the following oxides by weight percentages:
SiO₂: 65.00% to 75.00%,
Al₂O₃: 5.00% to 10.00%,
P₂O₅: 1.00% to 5.00%,
CaO: 0.10% to 3.00%,
ZrO₂: 1.00% to 10.00%,
Na₂O: 0% to 5.00%,
Li₂O: 5.00% to 15.00%,
K₂O: 0.10% to 3.00%, and
B₂O₃: 0% to 4.00%.

3. The strengthened glass-ceramic according to technical solution 1, wherein the tensile stress layer of the strengthened glass-ceramic comprises the following oxides by weight percentages:
SiO₂: 68.00% to 72.00%,
Al₂O₃: 5.00% to 10.00%,
P₂O₅: 1.00% to 3.00%,
CaO: 0.10% to 1.00%,
ZrO₂: 2.00% to 8.00%,
Na₂O: 0% to 1.00%,
Li₂O: 8.00% to 13.00%,
K₂O: 0.10% to 1.00%, and
B₂O₃: 0% to 2.00%.

4. The strengthened glass-ceramic according to technical solution 1, wherein the tensile stress layer of the strengthened glass-ceramic comprises the following oxides by weight percentages:
SiO₂: 70.00% to 72.00%,
Al₂O₃: 6.00% to 8.00%,
P₂O₅: 1.50% to 3.00%,
CaO: 0.50% to 1.00%,
ZrO₂: 5.00% to 7.00%,
Na₂O: 0.05% to 0.60%,
Li₂O: 9.00% to 12.00%,
K₂O: 0.10% to 0.50%, and
B₂O₃: 0.10% to 1.00%.

5. The strengthened glass-ceramic according to technical solution 1, wherein the tensile stress layer of the strengthened glass-ceramic comprises the following oxides by weight percentages:
SiO₂: 70.06% to 71.65%,
Al₂O₃: 7.24% to 7.43%,
P₂O₅: 2.49% to 2.83%,
CaO: 0.77% to 0.98%,
ZrO₂: 5.40% to 6.11%,
Na₂O: 0.06% to 0.31%,
Li₂O: 11.10% to 11.95%,
K₂O: 0.13% to 0.37%, and
B₂O₃: 0.21% to 0.91%.

6. The strengthened glass-ceramic according to any one of technical solutions 1 to 5, wherein a total content of petalite crystalline phase and lithium disilicate crystalline phase in the strengthened glass-ceramic is greater than or equal to 75 wt %.

7. The strengthened glass-ceramic according to any one of technical solutions 1 to 6, wherein the strengthened glass-ceramic has an average sandpaper drop resistance height of between 1.30 m and 1.80 m when the strengthened glass-ceramic with a thickness of 0.7 mm is tested for sandpaper drop resistance with an 80-mesh sandpaper.

8. The strengthened glass-ceramic according to any one of technical solutions 1 to 7, wherein the strengthened glass-ceramic with a thickness of 0.7 mm is transparent and has a transmittance of not less than 90.00% for light at a wavelength of 550 nm.

9. A preparation method of the strengthened glass-ceramic according to any one of technical solutions 1 to 8, comprising the following steps:
(1) preparing a base glass: mixing glass raw materials, adding with a clarifying agent, and forming the base glass by melt molding and annealing;
(2) preparing a glass-ceramic: subjecting the base glass obtained in step (1) to a nucleation treatment and a crystallization treatment to obtain the glass-ceramic;
(3) subjecting the glass-ceramic obtained in step (2) to cold working to obtain a polished sheet; and
(4) subjecting the polished sheet obtained in step (3) to chemical strengthening to obtain a strengthened glass-ceramic.

10. The preparation method according to technical solution 9, wherein in step (1), an annealing temperature is 450° C. to 600° C., preferably 450° C. to 550° C., and an annealing time is 6 hours to 240 hours, preferably 6 hours to 120 hours. The annealing can be divided into four stages: heating, holding, slow cooling and rapid cooling. Theoretically, at a certain temperature, the longer the annealing time, the less the residual stress, but considering the time cost, the time should not be too long. Different specifications of sample bricks need different annealing time to reduce a thermal stress of sample bricks to an usable range, and the larger the size of sample bricks, the longer the annealing time.

11. The preparation method according to technical solution 9 or 10, wherein in step (2), the nucleation temperature is 500° C. to 700° C., preferably 540° C. to 570° C., and preferably, nucleation time is 10 min to 1440 min.

12. The preparation method according to technical solution 11, wherein in step (2), during the nucleation treatment, the temperature is raised to the nucleation temperature at a heating rate of 5° C./min to 20° C./min, preferably at a heating rate of 10° C./min.

13. The preparation method according to any one of technical solutions 9 to 12, wherein in step (2), during the crystallization treatment, the crystallization temperature is 640° C. to 750° C., preferably 660° C. to 740° C., or 670° C. to 740° C., and preferably, the crystallization treatment time is 5 min to 1440 min.

14. The preparation method according to technical solution 13, wherein in step (2), during the crystallization treatment, the temperature is raised to the crystallization temperature at a heating rate of 5° C./min to 20° C./min, preferably at a heating rate of 10° C./min.

15. The preparation method according to any one of technical solutions 9 to 14, wherein step (4) is performed by subjecting the polished sheet obtained in step (3) to chemical strengthening in a pure sodium salt or a lithium-sodium-potassium mixed salt bath at 380° C. to 550° C., for a strengthening time of preferably 1 h to 24 h.

16. The preparation method according to technical solution 15, wherein in step (4), a sodium ion in the salt bath is provided by one or more of sodium nitrate, sodium sulfate, and sodium carbonate; a potassium ion in the salt bath is provided by one or more of potassium nitrate, potassium sulfate, and potassium carbonate; and a lithium ion in the salt bath is provided by one or more of lithium nitrate, lithium sulfate, and lithium carbonate.

17. The preparation method according to technical solution 15 or 16, wherein the lithium-sodium-potassium mixed salt bath comprises the following components in terms of mass percentage: 0.1 wt % to 100 wt % of NaNO₃ and 0 wt % to 99.9 wt % of KNO₃; and further comprises 0 wt % to 10 wt % of LiNO₃ based on a total mass of NaNO₃ and KNO₃.

18. The preparation method according to technical solution 15 or 16, wherein the lithium-sodium-potassium mixed salt bath comprises the following components in terms of mass percentage: 30 wt % to 95 wt % of NaNO₃ and 5 wt % to 70 wt % of KNO₃, and further comprises 0.01 wt % to 1 wt %, and preferably 0.01 wt % to 0.1 wt % of LiNO₃ based on a total mass of NaNO₃ and KNO₃.

19. The preparation method according to any one of technical solutions 9 to 18, wherein the chemical strengthening in step (4) is performed for 1 to 3 times.

20. The preparation method according to any one of technical solutions 9 to 19, wherein in step (1), the clarifying agent is selected from the group consisting of NaCl, Sb₂O₃, As₂O₃, nitrate, sulfate, and a combination thereof, and preferably, a mass percentage of the clarifying agent added to the base glass is 0.10 wt % to 1.00 wt %, and more preferably, the mass percentage of the clarifying agent added to the base glass is 0.50 wt % to 1.00 wt %; and/or in step (1), the melt molding is performed at 1400° C. to 1650° C.

21. A strengthened glass-ceramic obtained by the preparation method according to any one of technical solutions 9 to 20.

22. Use of the strengthened glass-ceramic according to any one of technical solutions 1 to 8 or the strengthened glass-ceramic according to technical solution 21 as a protective cover in a mobile device.

When the strengthened glass-ceramic provided by the present application has following stress characteristics of 1.01%≥Δα≥0.65% (Δα=5×10⁻⁵×|CT_AV|+0.0026), (CS_50/DOL_0)≥0.332×(surface CS/|CT_CV|), DOL_0≥0.187t, the average sandpaper drop resistance height can be 1.30 m to 1.80 m under a condition of 80-mesh sandpaper. Compared with those of the prior arts, the drop resistance of the strengthened glass-ceramic of the present application on rough ground is significantly improved, and the strengthened glass-ceramic can be used as a protective cover material for smart terminal products such as mobile phones.

### BRIEF DESCRIPTION OF THE DRAWINGS

FIG. 1 shows a DSC diagram of the base glass in Example 3 of the present application, which is heated to 1000° C. at a rate of 10° C./min in nitrogen;

FIG. 2 shows a transmittance profile of the glass-ceramic in Example 3 of the present application at 200 nm to 1000 nm;

FIG. 3 shows an X-ray diffraction pattern of the glass-ceramic in Example 3 of the present application;

FIG. 4 shows a schematic diagram of dropping and breaking of the strengthened glass-ceramic of the present application.

### DETAILED DESCRIPTION

In order to solve the problem of insufficient drop resistance of glass-ceramics in the prior arts, the present application provides a transparent glass-ceramic with petalite and lithium disilicate as a main crystalline phase, which can be chemically strengthened to obtain a strengthened glass-ceramic. The strengthened glass-ceramic has a compressive stress layer on a surface and a tensile stress layer inside, and the tensile stress layer has the same components as that of the transparent glass-ceramic before strengthening because it has not undergone ion-exchange.

The strengthened glass-ceramic has the following stress characteristics:
DOL 0≥0.187 t, t is a thickness of the glass-ceramic;

$$1.01 \% \geq Δα \geq 0.65 \% , Δα = 5 \times {10}^{- 5} \times \vert CT\_AV \vert + 0.0026 ;$$

$$( CS\_ 50 / DOL\_ 0 ) \geq 0.332 \times ( surface CS / \vert CT\_CV \vert ) ;$$

Δα is a function positively related to an absolute value of the average tensile stress. When Δα>1.01% in strengthened glass-ceramic, the tensile stress of a glass-ceramic article will be too large, which will lead to a self-explosion of the glass-ceramic. When Δα<0.65%, the tensile stress of the glass-ceramic article will be small, and the drop resistance will be poor.

(CS_50/DOL_0)/(surface CS/|CT_CV|) is a comprehensive relationship among surface compressive stress, central tensile stress and stress layer depth. When (CS_50/DOL_0)<0.332×(surface CS/|CT_CV|), microcracks are easy to generate and expand inward when the glass contacts with sharp objects, thus reducing the drop resistance of the glass.

DOL_0 is a depth of the compressive stress layer. When DOL_0<0.187 t, the compressive stress layer is relatively shallow, and the cracks generated are more likely to penetrate the compressive stress layer and reach the tensile stress zone when the glass contacts with sharp objects, thus reducing the drop resistance of the glass.

In the present application, a person skilled in the art can select a thickness of the strengthened glass-ceramic as required. For example, in some embodiments, the thickness of the strengthened glass-ceramic is 0.2 mm to 2.0 mm.

The present application relates to a range of components of a strengthened glass-ceramic, wherein a tensile stress layer of the strengthened glass-ceramic comprises the following oxides by weight percentages:
SiO₂: 65.00% to 75.00%,
Al₂O₃: 5.00% to 10.00%,
P₂O₅: 1.00% to 5.00%,
CaO: 0.10% to 3.00%,
ZrO₂: 1.00% to 10.00%,
Na₂O: 0% to 5.00%,
Li₂O: 5.00% to 15.00%,
K₂O: 0.10% to 3.00%, and
B₂O₃: 0% to 4.00%.

In a preferred embodiment, the tensile stress layer of the strengthened glass-ceramic comprises the following oxides by weight percentages:
SiO₂: 68.00% to 72.00%, preferably 70.00% to 72.00%,
Al₂O₃: 5.00% to 10.00%, preferably 6.00% to 8.00%,
P₂O₅: 1.00% to 3.00%, preferably 1.50% to 3.00%,
CaO: 0.10% to 1.00%, preferably 0.50% to 1.00%,
ZrO₂: 2.00% to 8.00%, preferably 5.00% to 7.00%,
Na₂O: 0% to 1.00%, preferably 0.05% to 0.60%,
Li₂O: 8.00% to 13.00%, preferably 9.00% to 12.00%,
K₂O: 0.10% to 1.00%, preferably 0.10% to 0.50%, and
B₂O₃: 0% to 2.00%, preferably 0.10% to 1.00%.

In a more preferred embodiment, the tensile stress layer of the strengthened glass-ceramic comprises the following oxides by weight percentages:
SiO₂: 70.06% to 71.65%,
Al₂O₃: 7.24% to 7.43%,
P₂O₅: 2.49% to 2.83%,
CaO: 0.77% to 0.98%,
ZrO₂: 5.40% to 6.11%,
Na₂O: 0.06% to 0.31%,
Li₂O: 11.10% to 11.95%,
K₂O: 0.13% to 0.37% and
B₂O₃: 0.21% to 0.91%.

In the strengthened glass-ceramic of the present application, a total content of petalite crystalline phase and lithium disilicate crystalline phase accounts for greater than or equal to 75 wt %, preferably greater than or equal to 79 wt %, and more preferably greater than or equal to 80 wt % of the strengthened glass-ceramic. The strengthened glass-ceramic are accompanied by possible heterogeneous phases such as quartz, spodumene, lithium metasilicate, etc. Lithium disilicate Li₂Si₂O₅ is an orthorhombic crystal, which is often flattened with an obvious cleavage plane. This crystalline phase forces cracks to expand along twisted grain boundaries due to its irregular orientation, which reduces the possibility of crack expansion. Petalite LiAlSi₄O₁₀ is a monoclinic crystal, with Li and O being tetrahedrally coordinated, and petalite can be chemically strengthened in a salt bath, where Na⁺ in the salt bath replaces some of Li⁺ in the petalite.

In some embodiments, the strengthened glass-ceramic of the present application contains a petalite crystalline phase and a lithium disilicate crystalline phase with a total content of 79 wt % to 97 wt %. In some embodiments, the strengthened glass-ceramic of the present application contains a petalite crystalline phase and a lithium disilicate crystalline phase with a total content of 79 wt %, 80.00 wt %, 81.00 wt %, 82.00 wt %, 83.00 wt %, 84.00 wt %, 85.00 wt %, 86.00 wt %, 87.00 wt %, 88.00 wt %, 89.00 wt %, 90.00 wt %, 91.00 wt %, 92.00 wt %, 93.00 wt %, 94.00 wt %, 95.00 wt %, 96.00 wt %, or 97.00 wt %, or any percentage within a numerical range of any two of the above specified values as endpoints. It should be understood that in specific embodiments, any of the above ranges may be combined with any other ranges as desired, as long as a glass with a desired property of the present application is obtained.

In some embodiments, the strengthened glass-ceramic has an average grain size of 10 nm to 50 nm, preferably 10 nm to 30 nm, and more preferably 10 nm to 20 nm. In some embodiments, the average grain size may be 10 nm, 12 nm, 14 nm, 16 nm, 18 nm, 20 nm, 22 nm, 24 nm, 26 nm, 28 nm, 30 nm, 35 nm, 38 nm, 40 nm, 45 nm, 48 nm, or 50 nm, or any value within a numerical range of any two of the above specified values as endpoints. It should be understood that in specific embodiments, any of the above ranges may be combined with any other ranges as desired, as long as the glass-ceramic of the present application is obtained.

The strengthened glass-ceramic of the present application also has the following stress characteristics:
surface CS: 200 MPa to 680 MPa;
CS 50:100 MPa to 400 MPa;
CS 100:20 MPa to 150 MPa;
   |CT_CV|: 50 MPa to 210 MPa;
   |CT_AV|: 55 MPa to 150 MPa;
CT_LD: 45000 MPa/mm to 90000 MPa/mm.

Drop resistance performance/anti-drop performance of the strengthened glass-ceramic:

The strengthened glass-ceramic has an average sandpaper drop resistance height of between 1.30 m and 1.80 m when the strengthened glass-ceramic with a thickness of 0.7 mm is tested for sandpaper drop resistance with an 80-mesh sandpaper.

The strengthened glass-ceramic has an average sandpaper drop resistance height of more than 2.00 m when the strengthened glass-ceramic with a thickness of 0.7 mm is tested for sandpaper drop resistance with an 120-mesh sandpaper.

The strengthened glass-ceramic has an average sandpaper drop resistance height of more than 2.50 m when the strengthened glass-ceramic with a thickness of 0.7 mm is tested for sandpaper drop resistance with an 180-mesh sandpaper.

Optical performance of the strengthened glass-ceramic:

The strengthened glass-ceramic is tested for a transmittance under the light with the wavelength of 200 nm to 1000 nm, as shown in FIG. 2. As shown in FIG. 2, in the visible wavelengths, the transmittance of the strengthened glass-ceramic is high, and the transparency is good.

The strengthened glass-ceramic with a thickness of 0.7 mm is transparent and has a transmittance of not less than 90.00% for light at a wavelength of 550 nm.

According to the application, preparing the glass-ceramic with high crystal content by ceramic treatment of the lithium-aluminum-silica glass, and putting the glass-ceramic into a pure sodium salt or a mixed salt of lithium, sodium and potassium for chemical strengthening, so that the strengthened glass-ceramic can meet the stress characteristic requirements and obtain better drop resistance performance.

SiO₂, as a formation oxide of glass network, is an indispensable component of glass network structure. Properly increasing the content of SiO₂ can increase the stability and mechanical strength of the glass. However, excessive SiO₂ will increase the viscosity of glass and cause a difficulty in glass melting. Therefore, in the present application, when the content of SiO₂ is controlled at 65.00 wt % to 75.00 wt %, the effect of increasing the stability and formability of the glass is the best. In some embodiments, the weight percentage of SiO₂ is 68.00% to 72.0%. In some embodiments, the weight percentage of SiO₂ is 70.00% to 72.0%. In some embodiments, the weight percentage of SiO₂ is 70.06% to 71.65%. In some embodiments, the tensile stress layer of the strengthened glass-ceramic may comprise SiO₂ with a weight percentage of 65.00% to 71.00%, 66.00% to 71.00%, 67.00% to 71.00%, 68.00% to 71.00%, 68.00% to 69.50%, 67.00% to 69.50%, 68.00% to 71.00%, 67.30% to 71.00%, 67.50% to 71.00%, 67.70% to 71.00%, 68.20% to 71.00%, 68.50% to 71.00%, 68.80% to 71.00%, 69.00% to 71.00%, 69.00% to 69.80%, 69.00% to 69.50%, 69.00% to 69.30%, 69.50% to 70.00%, 70.00% to 70.50%, 71.00% to 71.50% or 71.50% to 72.00%. In some embodiments, the tensile stress layer of the strengthened glass-ceramic may comprise SiO₂ with a weight percentage of 65.00%, 66.00%, 67.00%, 67.10%, 67.20%, 67.30%, 67.40%, 67.50%, 67.60%, 67.70%, 67.80%, 67.90%, 68.00%, 68.10%, 68.20%, 68.30%, 68.40%, 68.50%, 68.60%, 68.70%, 68.80%, 68.90%, 69.00%, 69.10%, 69.20%, 69.30%, 69.40%, 69.50%, 69.60%, 69.70%, 69.80%, 69.90%, 71.00%, 72.00%, 73.00%, 74.00% or 75.00%, or any percentage within a numerical range of any two of the above specified values as endpoints. It should be understood that in specific embodiments, any of the above ranges may be combined with any other ranges, as long as a glass-ceramic of the present application is obtained.

Al₂O₃ is an intermediate oxide of glass formation, which can improve the chemical stability of the glass. At the same time, because the volume of [AlO₄] is larger than that of [SiO₄], it can provide more space for ion exchange, so alumina can promote ion exchange. However, excessive Al₂O₃ tends to increase the viscosity of the glass, and when alkaline earth metals exist, it will also increase the crystallization tendency of the glass. Therefore, the content of Al₂O₃ is controlled at 5.00 wt % to 10.00 wt % in the present application. In some embodiments, the weight percentage of Al₂O₃ is 6.00% to 8.00%. In some embodiments, the weight percentage of Al₂O₃ is 7.24% to 7.43%. In some embodiments, the tensile stress layer of the strengthened glass-ceramic may comprise Al₂O₃ with a weight percentage of 5.00%, 5.30%, 5.50%, 5.80%, 6.00%, 6.30%, 6.50%, 6.80%, 7.00%, 7.30%, 7.50%, 7.80%, 8.00%, 8.30%, 8.50%, 8.80%, 9.00%, 9.30%, 9.50%, 9.80% or 10.00%, or any percentage within a numerical range of any two of the above specified values as endpoints. It should be understood that in a specific embodiment, any of the above ranges can be combined with any other range as long as the glass-ceramic of the present application can be obtained.

P₂O₅ can be used as a formation oxide of glass network, which can promote the phase separation of glass, thus affecting the crystallization of glass. In the transparent glass-ceramic of Li₂O—Al₂O₃—SiO₂ system, the content of P₂O₅ is controlled at 1.00 wt % to 5.00 wt %. In some embodiments, the weight percentage of P₂O₅ can be 1.00% to 3.00%. In some embodiments, the weight percentage of P₂O₅ can be 1.50% to 3.00%. In some embodiments, the weight percentage of P₂O₅ can be 2.49 to 2.83%. In some embodiments, the tensile stress layer of the strengthened glass-ceramic may comprise P₂O₅ with a weight percentage of 1.00%, 1.20%, 1.50%, 1.70%, 1.80%, 2.00%, 2.20%, 2.50%, 2.80%, 3.00%, 3.20%, 3.50%, 3.80%, 4.00%, 4.20%, 4.50%, 4.80% or 5.00%, or any percentage within a numerical range of any two of the above specified values as endpoints. It should be understood that in specific embodiments, any of the above ranges may be combined with any other ranges, as long as a glass-ceramic of the present application is obtained.

ZrO₂ is an intermediate oxide of glass formation, which can improve the chemical stability, hardness, scratch resistance and drop resistance of glass. At the same time, ZrO₂ is often used as a nucleating agent in glass-ceramic because of its high cationic charge and strong field. However, excessive ZrO₂ will greatly increase the viscosity of the glass and affect the glass forming ability. In the transparent glass-ceramic of Li₂O—Al₂O₃—SiO₂ system of the present application, the content of ZrO₂ is controlled at 1.00 wt % to 10.00 wt %. In some embodiments, the weight percentage of ZrO₂ can be 2.00 to 8.00%. In some embodiments, the weight percentage of ZrO₂ can be 5.00% to 7.00%. In some embodiments, the weight percentage of ZrO₂ can be 5.40% to 6.11%. In some embodiments, the tensile stress layer of the strengthened glass-ceramic may comprise ZrO₂ with a weight percentage of 1.00%, 1.20%, 1.40%, 1.60%, 1.80%, 2.00%, 2.20%, 2.40%, 2.60%, 2.80%, 3.00%, 3.20%, 3.40%, 3.60%, 3.80%, 4.00%, 4.20%, 4.40%, 4.60%, 4.80%, 5.00%, 5.20%, 5.40%, 5.60%, 5.80%, 6.00%, 6.20%, 6.40%, 6.60%, 6.80%, 7.00%, 7.20%, 7.40%, 7.60%, 7.80%, 8.00%, 8.20%, 8.40%, 8.60%, 8.80%, 9.00%, 9.20%, 9.40%, 9.6%, 9.8% or 10.0%, or any percentage within a numerical range of any two of the above specified values as endpoints. It should be understood that in specific embodiments, any of the above ranges may be combined with any other ranges, as long as a glass-ceramic of the present application is obtained.

CaO, as a modifier oxide of glass formation, helps to reduce the viscosity of glass, inhibits the crystallization of glass during glass forming, and improves the low-temperature melting of glass, but excessive CaO will reduce the devitrification resistance of glass. By adding a proper amount of CaO, the viscosity of glass can be reduced without affecting the crystallization performance of glass. Therefore, the content of CaO is controlled at 0.10 wt % to 3.00 wt % in this application. In some embodiments, the weight percentage of CaO is 0.10% to 1.00%. In some embodiments, the weight percentage of CaO is 0.50% to 1.00%. In some embodiments, the weight percentage of CaO is 0.77% to 0.98%. In some embodiments, the tensile stress layer of the strengthened glass-ceramic may comprise CaO with a weight percentage of 0.10%, 0.15%, 0.18%, 0.20%, 0.25%, 0.28%, 0.30%, 0.35%, 0.38%, 0.40%, 0.45%, 0.48%, 0.50%, 0.55%, 0.58%, 0.60%, 0.65%, 0.68%, 0.70%, 0.75%, 0.78%, 0.80%, 0.85%, 0.88%, 0.90%, 0.95%, 0.98%, 1.00%, 1.50%, 1.75%, 2.00%, 2.25%, 2.50%, 2.75% or 3.00%, or any percentage within a numerical range of any two of the above specified values as endpoints. It should be understood that in specific embodiments, any of the above ranges may be combined with any other ranges, as long as a glass-ceramic of the present application is obtained.

Li₂O, Na₂O and K₂O, as a network modifier oxides of glass formation, can optimize a viscosity of the glass and promote melting and clarification of molten glass. At the same time, Li₂O and Na₂O can exchange ions with molten salt bath, and their contents are an important factor affecting the stress of glass. In addition, Li₂O is also an essential chemical component for the formation of crystalline phases such as lithium disilicate (Li₂Si₂O₅), lithium metasilicate (Li₂SiO₃) and petalite (LiAlSi₄O₁₀). However, the free oxygen provided by Li₂O, Na₂O and K₂O will destroy the network structure of the glass, and affect the intrinsic strength of glass. Therefore, the present application controls the content of Li₂O within 5.00 wt % to 15.00 wt %, the content of Na₂O within 0 wt % to 5.00 wt % and the content of K₂O within 0.10 wt % to 3.00 wt %.

In some embodiments, the content of Li₂O is controlled at 8.00 wt % to 13.00 wt %. In some embodiments, the content of Li₂O is controlled at 9.00 wt % to 12.00 wt %. In some embodiments, controlling the content of Li₂O is controlled at 11.10 wt % to 11.95 wt %.

In some embodiments, the tensile stress layer of the strengthened glass-ceramic may comprise Li₂O with a weight percentage of 5.00%, 5.50%, 6.00%, 6.50%, 7.00%, 7.50%, 8.00%, 8.10%, 8.15%, 8.20%, 8.25%, 8.30%, 8.35%, 8.40%, 8.45%, 8.50%, 8.55%, 8.60%, 8.65%, 8.70%, 8.75%, 8.80%, 8.85%, 8.90%, 8.95%, 8.90%, 8.95%, 9.00%, 9.10%, 9.15%, 9.20%, 9.25%, 9.30%, 9.35%, 9.40%, 9.45%, 9.50%, 9.55%, 9.60%, 9.65%, 9.70%, 9.75%, 9.80%, 9.85%, 9.90%, 9.95%, 10.00%, 10.10%, 10.15%, 10.20%, 10.25%, 10.30%, 10.35%, 10.40%, 10.45%, 10.50%, 10.55%, 10.60%, 10.65%, 10.70%, 10.75%, 10.80%, 10.85%, 10.90%, 10.95%, 11.00%, 11.10%, 11.15%, 11.20%, 11.25%, 11.30%, 11.35%, 11.40%, 11.45%, 11.50%, 11.55%, 11.60%, 11.65%, 11.70%, 11.75%, 11.80%, 11.85%, 11.90%, 11.95%, 12.00%, 12.10%, 12.15%, 12.20%, 12.25%, 12.30%, 12.35%, 12.40%, 12.45%, 12.50%, 12.55%, 12.60%, 12.65%, 12.70%, 12.75%, 12.80%, 12.85%, 12.90%, 12.95%, 13.00%, 13.50%, 14.00%, 14.50% or 15.00%, or any percentage within a numerical range of any two of the above specified values as endpoints. It should be understood that in specific embodiments, any of the above ranges may be combined with any other ranges, as long as a glass-ceramic of the present application is obtained.

In some embodiments, the content of Na₂O is controlled at 0.01 wt % to 1.00 wt %. In some embodiments, the content of Na₂O is controlled at 0.05 wt % to 0.60 wt %. In some embodiments, the content of Na₂O is controlled at 0.06 wt % to 0.31 wt %.

In some embodiments, the tensile stress layer of the strengthened glass-ceramic may comprise Na₂O with a weight percentage of 0.01%, 0.02%, 0.03%, 0.04%, 0.05%, 0.06%, 0.07%, 0.08%, 0.09%, 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, 0.30%, 0.31%, 0.32%, 0.33%, 0.34%, 0.35%, 0.36%, 0.37%, 0.38%, 0.39%, 0.40%, 0.41%, 0.42%, 0.43%, 0.44%, 0.45%, 0.46%, 0.47%, 0.48%, 0.49%, 0.50%, 0.51%, 0.52%, 0.53%, 0.54%, 0.55%, 0.56%, 0.57%, 0.58%, 0.59%, 0.60%, 0.61%, 0.62%, 0.63%, 0.64%, 0.65%, 0.66%, 0.67%, 0.68%, 0.69%, 0.70%, 0.71%, 0.72%, 0.73%, 0.74%, 0.75%, 0.76%, 0.77%, 0.78%, 0.79%, 0.80%, 0.81%, 0.82%, 0.83%, 0.84%, 0.85%, 0.86%, 0.87%, 0.88%, 0.89%, 0.90%, 0.91%, 0.92%, 0.93%, 0.94%, 0.95%, 0.96%, 0.97%, 0.98%, 0.99%, 1.00%, 2.00%, 3.00%, 4.00% or 5.00%, or any percentage within a numerical range of any two of the above specified values as endpoints. It should be understood that in specific embodiments, any of the above ranges may be combined with any other ranges, as long as a glass-ceramic of the present application is obtained.

In some embodiments, the content of K₂O is controlled at 0.10 wt % to 1.00 wt %. In some embodiments, the content of the K₂O is controlled at 0.10 wt % to 0.50 wt %.

In some embodiments, the tensile stress layer of the strengthened glass-ceramic may comprise K₂O with a weight percentage of 0.10%, 0.11%, 0.12%, 0.13%, 0.14%, 0.15%, 0.16%, 0.17%, 0.18%, 0.19%, 0.20%, 0.21%, 0.22%, 0.23%, 0.24%, 0.25%, 0.26%, 0.27%, 0.28%, 0.29%, 0.30%, 0.31%, 0.32%, 0.33%, 0.34%, 0.35%, 0.36%, 0.37%, 0.38%, 0.39%, 0.40%, 0.41%, 0.42%, 0.43%, 0.44%, 0.45%, 0.46%, 0.47%, 0.48%, 0.49%, 0.50%, 0.51%, 0.52%, 0.53%, 0.54%, 0.55%, 0.56%, 0.57%, 0.58%, 0.59%, 0.60%, 0.61%, 0.62%, 0.63%, 0.64%, 0.65%, 0.66%, 0.67%, 0.68%, 0.69%, 0.70%, 0.71%, 0.72%, 0.73%, 0.74%, 0.75%, 0.76%, 0.77%, 0.78%, 0.79%, 0.80%, 0.81%, 0.82%, 0.83%, 0.84%, 0.85%, 0.86%, 0.87%, 0.88%, 0.89%, 0.90%, 0.91%, 0.92%, 0.93%, 0.94%, 0.95%, 0.96%, 0.97%, 0.98%, 0.99%, 1.00%, 2.00% or 3.00%, or any percentage within a numerical range of any two of the above specified values as endpoints. It should be understood that in specific embodiments, any of the above ranges may be combined with any other ranges, as long as a glass-ceramic of the present application is obtained.

B₂O₃, as a fluxing agent in the process of glass formation, and can reduce the high-temperature viscosity of glass, accelerate the clarification of glass, and reduce the crystallization ability of glass. However, excessive B₂O₃ will reduce the chemical stability and mechanical strength of the glass. Therefore, the content of B₂O₃ is controlled at 0 wt % to 4.00 wt %. In some embodiments, the content of B₂O₃ is controlled at 0% to 2.00%. In some embodiments, the content of B₂O₃ is controlled at 0.10% to 1.00%. In some embodiments, the content of B₂O₃ is controlled at 0.21% to 0.91%. In some embodiments, the tensile stress layer of the strengthened glass-ceramic may comprise B₂O₃ with a weight percentage of 0.10%, 0.15%, 0.18%, 0.20%, 0.25%, 0.28%, 0.30%, 0.35%, 0.38%, 0.40%, 0.45%, 0.48%, 0.50%, 0.55%, 0.58%, 0.60%, 0.65%, 0.68%, 0.70%, 0.75%, 0.78%, 0.80%, 0.85%, 0.88%, 0.90%, 0.95%, 0.98%, 1.00%, 1.10%, 1.15%, 1.18%, 1.20%, 1.25%, 1.28%, 1.30%, 1.35%, 1.38%, 1.40%, 1.45%, 1.48%, 1.50%, 1.55%, 1.58%, 1.60%, 1.65%, 1.68%, 1.70%, 1.75%, 1.78%, 1.80%, 1.85%, 1.88%, 1.90%, 1.95%, 1.98%, 2.00%, 2.10%, 2.15%, 2.18%, 2.20%, 2.25%, 2.28%, 2.30%, 2.35%, 2.38%, 2.40%, 2.45%, 2.48%, 2.50%, 2.55%, 2.58%, 2.60%, 2.65%, 2.68%, 2.70%, 2.75%, 2.78%, 2.80%, 2.85%, 2.88%, 2.90%, 2.95%, 2.98%, 3.00%, 3.10%, 3.15%, 3.18%, 3.20%, 3.25%, 3.28%, 3.30%, 3.35%, 3.38%, 3.40%, 3.45%, 3.48%, 3.50%, 3.55%, 3.58%, 3.60%, 3.65%, 3.68%, 3.70%, 3.75%, 3.78%, 3.80%, 3.85%, 3.88%, 3.90%, 3.95%, 3.98% or 4.00%, or any percentage within a numerical range of any two of the above specified values as endpoints. It should be understood that in specific embodiments, any of the above ranges may be combined with any other ranges, as long as a glass-ceramic of the present application is obtained.

### Explanation of Terms

Base glass: it is a glass that has not been subjected to a nucleation treatment, a crystallization treatment, and a strengthening treatment.

Glass-ceramic: it is also known as microcrystalline glass, which is a class of solid composite materials containing both glass and crystal phases (or also known as microcrystalline phase and crystallization phases) prepared by targeted controlled crystallization of the base glass.

Nucleation: it is a growth of small crystal nucleus of a nucleating material in the glass by heat treatment.

Crystallization: it is a growth of some kind of crystals on the basis of nuclei in glass by heat treatment.

Crystalline phase: a crystalline phase is a microstructure of a crystal, which is a general term for a large number of crystalline solid phases.

CT_LD: tensile stress linear density, a ratio of a sum of tensile stresses of the strengthened glass-ceramic measured by SLP-2000 stress meter to the glass thickness.

The glass-ceramic is subjected to ion exchange in a salt bath to form a compressive stress layer (i.e., a strengthened layer), and a tensile stress layer is formed within the glass during the ion exchange process. Specifically, during chemical strengthening, ions with large radius in the salt bath exchange with ions with small radius in the glass, thus forming a compressive stress layer on a glass surface and a tensile stress layer inside the glass. Compared with the glass-ceramic before strengthening, the component of the compressive stress layer will change due to ion exchange. Because a depth of ion exchange is usually less than or equal to a thickness of the compressive stress layer, the component of the tensile stress layer in the glass will not change, that is, the component of the tensile stress layer is the same as that of the glass-ceramic before strengthening.

The tensile stress layer has an upper boundary spaced at a distance from the upper surface of the strengthened glass-ceramic and a lower boundary spaced at a distance from the lower surface of the strengthened glass-ceramic. A tensile stress curve is recorded and drawn as a curve, in which a Y-axis refers to the tensile stress at a point on a line segment, which is in the tensile stress layer and is perpendicular to both the upper and lower boundaries, with upper and lower endpoints falling on the upper and lower boundaries respectively, and an X-axis refers to a distance between said point and the upper boundary. A ratio of the definite integral of the tensile stress curve to a thickness of the strengthened microcrystalline glass is recorded as the tensile stress linear density, which is a ratio of a sum of tensile stresses of the strengthened microcrystalline glass measured by the SLP-2000 stress meter to the thickness of the glass.

|CT_AV|: it is an absolute value of an average tensile stress, specifically the absolute value of the average value of all tensile stresses in the tensile stress layer, obtained by the SLP-2000 stress meter test.

DOL_0: it is a depth of the compressive stress layer, specifically the distance from any surface of the strengthened glass-ceramic to the position where the compressive stress close to that surface is zero, obtained by SLP-2000 stress meter test.

|CT_CV|: it is an absolute value of the central maximum tensile stress or the maximum tensile stress, specifically the absolute value of the maximum value of all tensile stresses in the tensile stress layer, obtained by the SLP-2000 stress meter test.

Surface compressive stress: surface CS, glass-ceramic or glass-ceramic after chemical strengthening, the alkali metal ions having a smaller surface radius are replaced by the alkali metal ions having a larger radius, due to the “crowding” effect of the alkali metal ions having a larger radius, the glass surface thus generates compressive stresses, which is known as surface compressive stress. Surface CS is obtained by SLP-2000 stress meter.

CS_50: it is a compressive stress at a depth of 50 μm from the strengthened glass-ceramic surface.

CS_100: it is a compressive stress at a depth of 100 μm from the strengthened glass-ceramic surface.

Transmittance: it is a ratio of a radiant energy projected and transmitted through an object to a total radiant energy projected onto the object as the incident light flux leaves from an illuminated surface or an incident side of a medium to the other side.

Refractive index: it is a ratio of a speed of propagation of light in vacuum to the speed of propagation of light in a medium.

In the Examples and Comparative Examples of the present application, the transmittance of the glass-ceramic at a wavelength of 550 nm is an average of the transmittance measured at a wavelength of 550 nm for a plurality of glass samples from the same batch. At least 5 samples of glass-ceramic from each batch are taken for testing.

SOC: it is a photoelastic coefficient. Photoelasticity mainly refers to an anisotropic birefringence phenomenon that occurs in transparent materials after being subjected to a force. Through a measurement of stress optical coefficient and birefringence, the value of an internal residual stress (MPa) of a material can be obtained.

### Instruments and Test Methods

Thickness of the glass: determined by micrometer test. The change in a thickness of the glass-ceramic before and after chemical strengthening was very small and negligible.

Crystal content test: X-ray diffractometer was used to test the glass-ceramic samples, to obtain an XRD diffraction peak curve, and then the X-ray diffractometer (Shimadzu XRD-6000) test result file (RAW format) was imported into the X-ray diffraction data Rietveld refining software (e.g., Gsas, Fullprof, Maud), and then fitted and calculated, and the crystal content in the glass-ceramic sample can be obtained. The ratio of the peak area of the fitted crystalline phase and the total peak area of the fitted crystalline phase is the crystal content. The X-ray diffractometer used in the present application was Shimadzu XRD-6000, and the diffraction angle range used for the test was 2θ=10° to 50°, the scanning speed was 6°/min, the operating voltage was 40 kV, and the operating current was 30 mA.

The average grain size (or also known as, the average size of a grain) was obtained as follows: the glass-ceramic samples were tested using an X-ray diffractometer, and the resultant data obtained from the XRD test were used to obtain the average grain size using Scherrer's formula D =Kλ/(βcos θ), with λ being the wavelength of the X-rays, β being the half-height width of the peaks, and K=0.89.

Transmittance test: referring to the standard GB/T 7962.12-2010 Test Methods for Colorless Optical Glass Part 12: Intra-spectral Transmittance Ratio, the transmittance of the glass-ceramic was tested by a professional testing instrument. The testing instruments used in the present application are Konica Minolta Spectrophotometer CM-3600A from Japan and Shimadzu Ultraviolet Visible Spectrophotometer UV-2600.

Testing of surface compressive stress (surface CS), CS_50, CS_100, CT_AV, CT_CV, DOL_0: the test was performed using a stress meter SLP-2000 (ORIHARA, Japan) with a light source wavelength of 518 nm, SOC=25.5 (nm/cm)/MPa, refractive index=1.54, and an exposure time of 300 μsec.

To test the surface CS, CS_50, CS_100, CT_AV, CT_CV, DOL_0, it is necessary to put a drop of its special refractive solution on the stress meter, then wipe the strengthened glass-ceramic articles clean, put them on the test path, and test their values. The refractive index of the refractive solution used for SLP-2000 is 1.51.

The CT_LD correlates with the thickness of the glass sheet, the depth of strengthening and the average tensile stress and can be used to assess the drop resistance of the glass sheet. In the present application, the CT_LD satisfies the following equation:

$$CT\_LD = \frac{( 1000 d / 2 - DOL\_ 0 ) \times \vert CT\_AV \vert \times 2}{d} ,$$

wherein, d denotes the thickness of the glass-ceramic sheet (the thickness of the glass in the following Examples and Comparative Examples of the present application is 0.7 mm), the unit is mm; DOL_0 denotes the depth of the compressive stress layer, the unit is μm; and CT_AV denotes the internal average tensile stress, and the absolute value is taken in the calculation, the unit is MPa. In the present application, in the equation for the calculation of the tensile stress linear density, the data is substituted into for the calculation in accordance with the requirements for the above mentioned units, and the calculation result is obtained, the unit is not involved in the calculation.

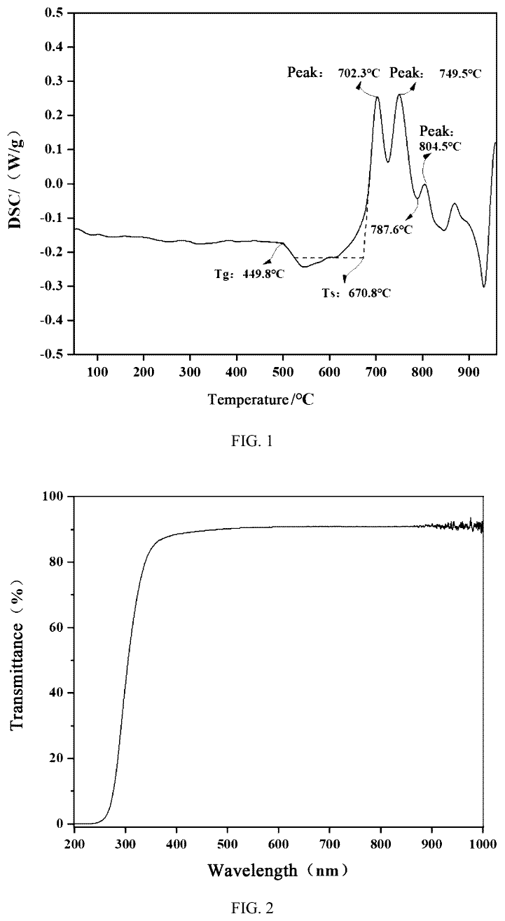

Differential scanning calorimetry (DSC) test: After grinding the sample, it passes through a 200-mesh sieve; the test conditions: room temperature to 1000° C., 10° C./min heating rate; the test instrument is Mettler-Toledo TGA/DSC3+thermogravimetric and synchronous thermal analyzer, and the test result diagram may refer to FIG. 1.

Average sandpaper drop resistance height: the value obtained by dividing the sum of sandpaper drop resistance heights measured by multiple glass samples by the number of samples measured, which is used to characterize the cracking resistance of glass contact surface.

At least 10 samples from each batch were taken for testing the average height of sandpaper drop resistance

$$〈 h 〉 n = \frac{1}{n} {\sum }_{i = 1}^{n} hi ,$$

wherein n is the number of glass samples tested in each batch, and hi is the sandpaper drop resistance height of a single sample.

Among them, the test method of the sandpaper drop resistance height of a single sample is as follows:
Step 1: sticking a glass sample to be tested with a length, width and thickness of 158.8 mm×72.8 mm×0.7 mm on the front of a 200 g model machine;
Step 2: placing the model machine on a green LT-SKDL-CD type dropping machine, making the glass sample face the sandpaper, and impacting the sandpaper with 80-mesh, 120-mesh or 180-mesh directly below the model machine to simulate the normal dropping posture of the mobile phone.

If the glass sample is not broken, the drop height of the model machine will be increased regularly. For example, the dropping height starts from 0.4 m, and a drop impact is carried out on the sample. If it is not broken, it will drop again by increasing the height by 0.1 m each time until the glass sample is broken.

Step 3: recording the previous one dropping height of the glass sample when it is broken as the sandpaper drop resistance height. For example, if the drop height is 0.5 m when it is broken, the sandpaper drop resistance height of the sample is 0.4 m.

### The Preparation Method of the Strengthened Glass-Ceramic of the Present Application Includes the Following Steps:

### (1) Preparation of Base Glass.

Mixing components according to formulation for 30 minutes, then adding a clarifying agent after mixing evenly, and melting the mixture in a platinum crucible at 1400° C. to 1650° C. for 5 hours, followed by pouring it into a molding die for molding and cooling to 900° C. Then placing the resultant into an annealing furnace at 450° C. to 600° C., preferably 450° C. to 550° C., and annealing for 6 hours to 240 hours, preferably 6 hours to 120 hours, and then cooling to room temperature in the furnace to obtain the base glass.

The clarifying agent can be a substance selected from the group consisting of NaCl, Sb₂O₃, As₂O₃, nitrate, sulfate, and a combination thereof, and the mass percentage of the clarifying agent added to the base glass raw material is 0.10 wt % to 1.00 wt %, that is, an amount of the clarifying agent accounts for 0.10 wt % to 1.00 wt % of a total amount of the base glass raw material.

### (2) Preparation of Glass-Ceramic.

A transparent glass-ceramic brick can be prepared by sequentially carrying out the following nucleation treatment and crystallization treatment on the base glass.

During the nucleation treatment, the temperature is raised to the nucleation temperature at a heating rate of 5° C./min to 20° C./min, preferably 10° C./min, the nucleation temperature is 500° C. to 700° C., and the nucleation treatment time is 10 min to 1440 min. During the crystallization treatment, the temperature is raised to the crystallization temperature at a heating rate of 5° C./min to 20° C./min, preferably 10° C./min, the crystallization temperature is 640° C. to 750° C., and the crystallization treatment time is 5 min to 1440 min. The nucleation treatment time herein refers to a holding time after the crystallization furnace was heated up to the set nucleation temperature at a set rate of heating. The crystallization treatment time herein refers to a holding time after the crystallization furnace after was heated up to the set crystallization temperature at a set rate of heating.

### (3) Cold Working of Samples.

Subjecting the glass-ceramic brick obtained in step (2) to a cold working treatment, comprising a slicing treatment, a shape-correction treatment which can be performed to the glass-ceramic brick before the slicing treatment, a CNC treatment, a grinding treatment, and a polishing treatment can be carried out in turn after the slicing treatment, or at least one method of CNC treatment, grinding treatment, and polishing treatment was carried out after the slicing treatment for a modification treatment of a glass sheet. A glass-ceramic samples with desired size, such as a polished sheet with a length, width and thickness of 50 mm×50 mm×0.7 mm, or 158.8 mm×72.8 mm×0.7 mm, etc, is obtained.

### (4) Chemical Strengthening.

Subjecting the glass-ceramic sample (e.g., polished sheet) obtained above to chemical strengthening in a pure sodium salt or lithium-sodium-potassium mixed salt bath at 380° C. to 550° C. for 1 h to 24 h, wherein a sodium ion in the salt bath is provided by one or more of sodium nitrate, sodium sulfate, and sodium carbonate, a potassium ion in the salt bath is provided by any one of potassium nitrate, potassium sulfate, and potassium carbonate, and a lithium ion in the salt bath is provided by one or more of lithium nitrate, lithium sulfate, and lithium carbonate. The present application can preferably use the mixed salt of lithium nitrate, sodium nitrate and potassium nitrate for chemical strengthening.

In some embodiments, the components of the strengthened salt bath in the present application is 0.1 wt % to 100 wt % NaNO₃ and 0 wt % to 99.9 wt % KNO₃, and the content of LiNO₃ is 0 wt % to 10 wt % relative to the total weight of the salt bath.

The strengthened glass-ceramic of the present application and the preparation method thereof are described in detail below by means of specific embodiments.

### EXAMPLES

Taking Example 3 as an example, the specific preparation process was as follows:

A total amount of 1000 g of various raw material powders were weighted into a blender according to the component percentages of base glass E shown in Table 1, and then 5 g of a clarifying agent (NaCl) was added, and mixed for 30 minutes. The resulting mixture was melted in a platinum crucible at 1650° C. for 5 hours, then poured into a molding die for molding, and cooled to 900° C. The resultant was placed into an annealing furnace at 480° C. for 12 hours, and then cooled with the furnace to room temperature (cooled to room temperature at a rate of about 5° C./min) to obtain a base glass sample brick. In other examples, the preparation method of base glass is the same as that of Example 3, in which the component percentages of base glass in Examples 1 to 6 and Comparative Examples 1 to 7 correspond to the component letters in Table 1 respectively, which are specifically described in Tables 2-2 and 2-1.

The base glass was put into an annealing furnace for a nucleation treatment and a crystallization treatment, the whole heating rate was set to be 10° C./min, the temperature was raised from room temperature to 545° C., and the temperature was kept at 545° C. for 4 hours for the nucleation treatment; then the temperature was raised to 675° C., and kept at 675° C. for 90 min for crystallization; and then cooled to room temperature with the furnace to obtain a glass-ceramic sample brick.

After shaping, slicing, CNC, flat grinding and polishing, the glass-ceramic sample sheet with desired size, such as a polished sheet with a length, width, and thickness of 50 mm×50 mm×0.7 mm, or 158.8 mm×72.8 mm×0.7 mm, etc., was obtained.

According to the salt bath proportion shown in Table 2-2, 700 g NaNO₃, 300 g KNO₃, and 0.3 g LiNO₃ were weighted (70 wt % NaNO₃+30 wt % KNO₃+0.03 wt % LiNO₃, wherein 0.03 wt % LiNO₃ refers to an additional mass proportion of LiNO₃ relative to the total mass of the mixed salt composed of NaNO₃ and KNO₃), and put into a crucible and melted into a liquid state in a strengthened furnace at a temperature of 480° C. The obtained polished sheet was put into molten salt bath, strengthened once at 480° C. for 7 hours, to obtain a strengthened glass-ceramic sheet.

The properties of the strengthened glass-ceramic were tested. After the stress was tested by SLP-2000, the whole machine drop test of sandpaper with different mesh numbers was carried out. The results are shown in Table 2-2.

Tables 2-1 and 2-2 show the specific conditions for strengthening the glass of Comparative Examples 1 to 7 and Examples 1 to 6, respectively, including the salt bath mass proportion, salt bath temperature and salt bath time (among them, Comparative Example 1 was subjected to secondary strengthening treatment (the salt baths used for strengthening treatment in the first strengthening and the second strengthening treatment are simply referred to as “first strengthening salt bath” and “second strengthening salt bath”, respectively), other Examples and Comparative Examples were only strengthened once). After different strengthening treatments, various stress tests and drop experiments were carried out on the specific samples of different strengthened glass-ceramic. The specific stress test data and drop experiment data are summarized in Table 2-1 and Table 2-2 respectively.

From the Comparative Examples 1 to 7 in Table 2-1, it can be seen that when the strengthened glass-ceramic cannot meet the requirements of 1.01%≥Δα≥0.65%, (CS_50/DOL_0)≥0.332×(surface CS/|CT_CV|) and DOL_0≥0.187 t at the same time, in the 80-mesh sandpaper machine drop test, the average sandpaper drop resistance height of its strengthened glass-ceramic is 0.88 m to 1.15 m.

Examples 1 to 6 in Table 2-2 show that the surface CS of the strengthened glass-ceramic of the present application is greater than 270 MPa, which is in the range of 272 MPa to 428 MPa; CS_50 is greater than 164 MPa, which is in the range of 164.44 MPa to 245.83 MPa. CS_100 is greater than 59.55 MPa, which is in the range of 59.55 MPa to 91.81 MPa. |CT_CV| is greater than 113 MPa, which is in the range of 113.54 MPa to 145.86 MPa; |CT_AV| is greater than 85 MPa, which is in the range of 85.49 MPa to 101.19 MPa; DOL_0 is greater than 130 μm, which is in the range of 130.60 μm to 151.57 μm; CT_LD is greater than 50000 MPa/mm, which is in the range of 50477.18 MPa/mm to 60721.55 MPa/mm. The strengthened glass-ceramic of the application has the characteristics of 1.01%≥Δα≥0.65%, (CS_50/DOL_0)≥0.332×(surface CS/CT_CV) and DOL_0≥0.187 t, and the average sandpaper drop resistance height of the strengthened glass-ceramic can reach 1.31 m or more in the 80-mesh sandpaper machine drop test. From Tables 2-1 and 2-2, it can be seen that the larger the mesh number of drop sandpaper is for the same glass sample, the greater the average height of sandpaper drop resistance. The larger the mesh of sandpaper, the smaller the coated emery particles and the shallower the puncture depth.

In addition, FIG. 1 of the present application is a DSC diagram of the base glass in Example 3 of the present application (component of glass E), which is raised to 1000° C. at a heating rate of 10° C./min in nitrogen. It can be seen from the figure that the nucleation temperature of the base glass of this formulation is 530° C. to 550° C., and the crystallization temperature is 670° C. to 700° C. FIG. 2 is a graph showing the transmittance of the glass-ceramic of Example 3 (component of glass E) in the range of 200 nm to 1000 nm measured by Shimadzu UV-2600 spectrophotometer. From this graph, it can be seen that the glass-ceramic of the present application has higher transmittance and better transparency in the visible wavelength.

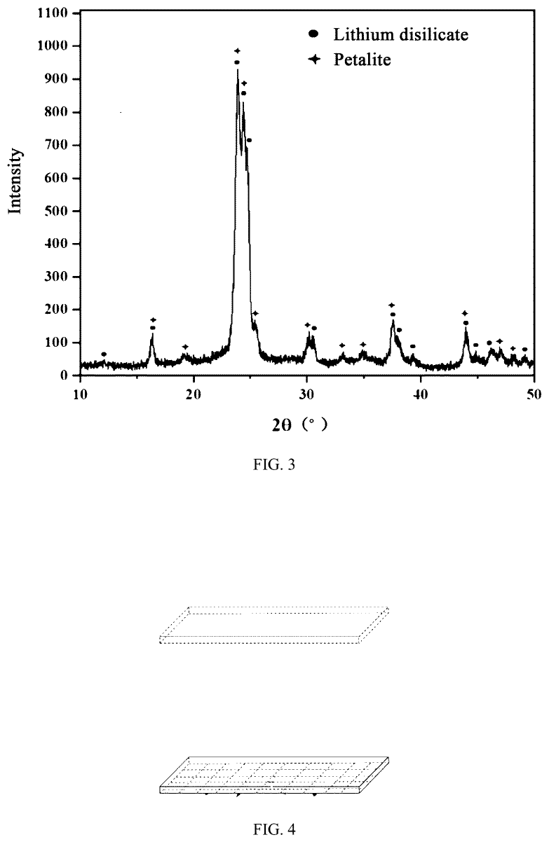

FIG. 3 is an X-ray diffraction pattern of the glass-ceramic of Example 3 (component of glass E) of the present application. From this diffraction pattern, it can be seen that the glass-ceramic of Example 3 mainly contains petalite and lithium disilicate crystalline phases.

TABLE 1
Formulation, heat treatment, crystalline phase
component and transmittance of glass-ceramic

| | Glass composition (wt %) | | | | | |
|---|---|---|---|---|---|---|
| | A | B | C | D | E | F |
| SiO₂ | 74.22% | 71.60% | 73.26% | 70.53% | 71.65% | 70.06% |
| Al₂O₃ | 7.50% | 7.11% | 7.22% | 7.09% | 7.24% | 7.43% |
| P₂O₅ | 2.00% | 2.45% | 2.03% | 2.46% | 2.49% | 2.83% |
| ZrO₂ | 4.32% | 4.81% | 3.56% | 4.38% | 5.40% | 6.11% |
| Na₂O | 0.00% | 1.58% | 1.57% | 3.89% | 0.31% | 0.06% |
| K₂O | 0.00% | 0.00% | 0.00% | 0.00% | 0.13% | 0.37% |
| Li₂O | 11.55% | 10.83% | 11.00% | 10.77% | 11.10% | 11.95% |
| CaO | 0.00% | 0.00% | 0.00% | 0.00% | 0.77% | 0.98% |
| B₂O₃ | 0.00% | 1.62% | 1.36% | 0.88% | 0.91% | 0.21% |
| SnO₂ | 0.41% | 0.00% | 0.00% | 0.00% | 0.00% | 0.00% |
| Total | 100.00% | 100.00% | 100.00% | 100.00% | 100.00% | 100.00% |
| Nucleation | 570/240 | 552/240 | 540/240 | 550/240 | 545/240 | 550/240 |
| temperature | | | | | | |
| (° C.)/Time (min) | | | | | | |
| Crystallization | 740/240 | 670/240 | 660/240 | 680/240 | 675/90 | 670/90 |
| temperature | | | | | | |
| (° C.)/Time (min) | | | | | | |
| Crystallization | 10 | 10 | 10 | 10 | 10 | 10 |
| heating rate | | | | | | |
| (C/min) | | | | | | |
| Main crystalline | Petalite, | Petalite, | Petalite, | Petalite, | Petalite, | Petalite, |
| phase | Lithium | Lithium | Lithium | Lithium | Lithium | Lithium |
| | disilicate | disilicate | disilicate | disilicate | disilicate | disilicate |
| crystalline phase | 86.32% | 79.84% | 85.75% | 83.37% | 83.84% | 80.93% |
| content (wt %) | | | | | | |
| Average grain | 15.8 | 18.8 | 16.4 | 16.6 | 16.7 | 19.3 |
| size/nm | | | | | | |
| 550 nm | 91.09 | 90.95 | 91.08 | 91.03 | 91.01 | 90.89 |
| Transmittance | | | | | | |
| (%) | | | | | | |

TABLE 2-1

| | Number | | | | | | |
|---|---|---|---|---|---|---|---|
| | Comparative | Comparative | Comparative | Comparative | Comparative | Comparative | Comparative |
| | Example 1 | Example 2 | Example 3 | Example 4 | Example 5 | Example 6 | Example 7 |
| | Composition | | | | | | |
| | A | B | C | D | D | E | E |
| Proportion of first | 40% NaNO₃ + | 100% | 100% | 100% | 90% NaNO₃ + | 95% NaNO₃ + | 100% |
| strengthening salt | 60% KNO₃ + | NaNO₃ | NaNO₃ | NaNO₃ | 10% KNO₃ | 5% KNO₃ + | NaNO₃ |
| bath/wt % | 0.1% LiNO₃ | | | | | 0.03% LiNO₃ | |
| Salt bath | 500 | 450 | 450 | 480 | 480 | 480 | 480 |
| temperature/° C. | | | | | | | |
| Salt bath time/h | 6 | 11 | 8 | 2.5 | 2.5 | 13 | 5 |
| Proportion of | 10% NaNO₃ + | / | / | / | / | / | / |
| second | 90% KNO₃ + | | | | | | |
| strengthening | 0.1% LiNO₃ | | | | | | |
| salt bath/wt % | | | | | | | |
| Salt bath | 500 | / | / | / | / | / | / |
| temperature/° C. | | | | | | | |
| Salt bath time/h | 5 | / | / | / | / | / | / |
| Surface CS/MPa | 193 | 285 | 271 | 183 | 170 | 231 | 370 |
| CS_50/MPa | 102.46 | 154.87 | 126.69 | 105.76 | 100.33 | 122.15 | 184.56 |
| CS_100/MPa | 39.62 | 51.11 | 43.61 | 39.34 | 38.98 | 32.94 | 41.56 |
| \|CT_CV\|/MPa | 89.32 | 90.30 | 79.15 | 69.38 | 80.41 | 84.09 | 101.13 |
| \|CT_AV\|/MPa | 80.11 | 65.57 | 51.02 | 49.94 | 79.92 | 63.53 | 80.63 |
| DOL_0 (μm) | 143.64 | 134.82 | 127.05 | 138.34 | 152.32 | 124.23 | 120.42 |
| CT_LD | 47232.86 | 40313.00 | 32499.89 | 30200.51 | 45138.82 | 40978.09 | 52889.44 |
| (MPa/mm) | | | | | | | |
| 1.01% ≥ Δα ≥ 0.65% | 0.66% | 0.59% | 0.52% | 0.51% | 0.66% | 0.58% | 0.66% |
| (CS_50/DOL_0)/ | 0.330 | 0.364 | 0.291 | 0.290 | 0.311 | 0.358 | 0.419 |
| (Surface | | | | | | | |
| CS/\|CT_CV\|) ≥ 0.332 | | | | | | | |
| Thickness of | 0.7 | 0.7 | 0.7 | 0.7 | 0.7 | 0.7 | 0.7 |
| galss-ceramict (mm) | | | | | | | |
| DOL_0/t ≥ 0.187 | 0.205 | 0.193 | 0.181 | 0.198 | 0.218 | 0.177 | 0.172 |
| 80-Mesh, An | 1.15 | 0.95 | 0.88 | 0.9 | 0.99 | 0.94 | 1.13 |
| average sandpaper | | | | | | | |
| drop resistance | | | | | | | |
| height (m) | | | | | | | |
| 120-Mesh, An | 1.68 | / | 1.51 | / | / | / | / |
| average sandpaper | | | | | | | |
| drop resistance | | | | | | | |
| height (m) | | | | | | | |
| 180-Mesh, An | 2.01 | / | 1.98 | / | / | / | / |
| average sandpaper | | | | | | | |
| drop resistance | | | | | | | |
| height (m) | | | | | | | |

Note:
In the table, “/” indicates that it does not exist or has not been determined.

TABLE 2-2

| | Number | | | | | |
|---|---|---|---|---|---|---|
| | Example 1 | Example 2 | Example 3 | Example 4 | Example 5 | Example 6 |
| | Composition | | | | | |
| | E | E | E | E | E | F |
| Proportion of first | 100% | 95% NaNO₃ + | 70% NaNO₃ + | 60% NaNO₃ + | 30% NaNO₃ + | 100% |
| strengthening salt | NaNO₃ | 5% KNO₃ + | 30% KNO₃ + | 40% KNO₃ + | 70% KNO₃ + | NaNO₃ |
| bath/wt % | | 0.03% LiNO₃ | 0.03% LiNO₃ | 0.03% LiNO₃ | 0.03% LiNO₃ | |
| Salt bath | 480 | 480 | 480 | 480 | 450 | 450 |
| temperature/° C. | | | | | | |
| Salt bath time/h | 9 | 11 | 7 | 8 | 9 | 11 |
| Proportion of second | / | / | / | / | / | / |
| strengthening salt | | | | | | |
| bath/wt % | | | | | | |
| Salt bath | / | / | / | / | / | / |
| temperature/° C. | | | | | | |
| Salt bath time/h | / | / | / | / | / | / |
| Surface CS/MPa | 362 | 317 | 352 | 338 | 272 | 428 |
| CS_50/MPa | 204.91 | 195.27 | 191.19 | 201.73 | 164.44 | 245.83 |
| CS_100/MPa | 73.06 | 88.91 | 59.55 | 82.61 | 71.10 | 91.81 |
| \|CT_CV\|/MPa | 133.34 | 145.86 | 113.54 | 128.50 | 129.73 | 137.34 |
| \|CT_AV\|/MPa | 95.65 | 97.74 | 85.49 | 91.12 | 87.02 | 101.19 |
| DOL_0(μm) | 136.66 | 151.57 | 130.60 | 144.38 | 146.97 | 139.97 |
| CT_LD(MPa/mm) | 58302.80 | 55412.73 | 53584.03 | 53527.83 | 50477.18 | 60721.55 |
| 1.01% ≥ Δα ≥ 0.65% | 0.74% | 0.75% | 0.69% | 0.72% | 0.70% | 0.77% |
| (CS_50/DOL_0)/ | 0.552 | 0.592 | 0.472 | 0.531 | 0.533 | 0.564 |
| (Surface | | | | | | |
| CS/\|CT_CV\|) ≥ 0.332 | | | | | | |
| Thickness of | 0.7 | 0.7 | 0.7 | 0.7 | 0.7 | 0.7 |
| galss-ceramic t (mm) | | | | | | |
| DOL_0/t ≥ 0.187 | 0.195 | 0.217 | 0.187 | 0.206 | 0.210 | 0.200 |
| 80-Mesh, An average | 1.43 | 1.39 | 1.40 | 1.38 | 1.31 | 1.49 |
| sandpaper drop | | | | | | |
| resistance height (m) | | | | | | |
| 120-Mesh, An | 2.15 | / | / | / | / | 2.21 |
| average sandpaper | | | | | | |
| drop resistance | | | | | | |
| height (m) | | | | | | |
| 180-Mesh, An | >2.5 | / | / | / | / | >2.5 |
| average sandpaper | | | | | | |
| drop resistance | | | | | | |
| height (m) | | | | | | |

Note:
Since the upper limit of the dropping machine used for drop resistance test is 2.5 m, if the glass is still unbroken after reaching the upper limit test height, it is judged that the average sandpaper drop resistance height of the glass is greater than 2.5 m. In the table, “/” indicates that it does not exist or has not been determined.

1-22. (canceled)

23. A terminal product, comprising a strengthened glass-ceramic, wherein the strengthened glass-ceramic comprises a petalite crystalline phase and a lithium disilicate crystalline phase; the strengthened glass-ceramic has a compressive stress layer formed by chemical strengthening on a surface and a tensile stress layer inside; and in the strengthened glass-ceramic:
DOL_0≥0.187 t, t is a thickness of the strengthened glass-ceramic;
$$1.01 \% \geq Δα > 0.66 \% , Δα = 5 \times {10}^{- 5} \times \vert CT\_AV \vert + 0.0026 ;$$
a tensile stress linear density CT_LD is 45000 MPa/mm to 90000 MPa/mm;

|CT_CV| is 50 MPa to 210 MPa; and
wherein:
CT_AV represents an average tensile stress in the tensile stress layer, measured in MPa;
CT_CV represents a maximum tensile stress in the tensile stress layer, measured in MPa; and
DOL_0 represents a depth of the compressive stress layer, measured in μm.

24. The terminal product according to claim 23, wherein in the strengthened glass-ceramic:
$$1.01 \% \geq Δα \geq 0.69 \% .$$

25. The terminal product according to claim 23, wherein in the strengthened glass-ceramic:

|CT_AV| is greater than 80.63 MPa; and/or

|CT_CV| is greater than 113 MPa; and/or
$$DOL\_ 0 \geq 0.195 t .$$

26. The terminal product according to claim 23, wherein in the strengthened glass-ceramic:
CS_50 is 100 MPa to 400 MPa; and/or
CS_100 is 20 MPa to 150 MPa;
wherein:
CS_50 represents a compressive stress at a depth of 50 μm from a glass surface, measured in MPa; and
CS_100 represents a compressive stress at a depth of 100 μm from the glass surface, measured in MPa.

27. The terminal product according to claim 23, wherein in the strengthened glass-ceramic:

|CT_AV| is 85.49 MPa to 101.19 MPa; and/or

|CT_CV| is 113.54 MPa to 145.86 MPa.

28. The terminal product according to claim 23, wherein in the strengthened glass-ceramic:
$$( CS\_ 50 / DOL\_ 0 ) \geq 0.332 \times ( surface CS / \vert CT\_CV \vert ) ;$$
wherein:
surface CS represents a surface compressive stress, measured in MPa.

29. The terminal product according to claim 23, wherein the strengthened glass-ceramic has a total content of the petalite crystalline phase and the lithium disilicate crystalline phase of greater than or equal to 75 wt %; and/or
the strengthened glass-ceramic has an average grain size of 10 nm to 50 nm.

30. The terminal product according to claim 23, wherein the tensile stress layer of the strengthened glass-ceramic comprises the following oxides by weight percentages:
65.00% to 75.00% of SiO₂, 5.00% to 10.00% of Al₂O₃, 1.00% to 5.00% of P₂O₅, 1.00% to 10.00% of ZrO₂, and 5.00% to 15.00% of Li₂O.

31. The terminal product according to claim 23, wherein the strengthened glass-ceramic with a thickness of 0.7 mm is transparent and has a transmittance of not less than 90.00% for light at a wavelength of 550 nm; and/or
the strengthened glass-ceramic has an average sandpaper drop resistance height of between 1.30 m and 1.80 m when the strengthened glass-ceramic with a thickness of 0.7 mm is tested for sandpaper drop resistance with an 80-mesh sandpaper.

32. A strengthened glass-ceramic, comprising a petalite crystalline phase and a lithium disilicate crystalline phase, wherein the strengthened glass-ceramic has a compressive stress layer formed by chemical strengthening on a surface and a tensile stress layer inside; and in the strengthened glass-ceramic:
DOL_0≥0.187 t, t is a thickness of the strengthened glass-ceramic;
$$1.01 \% \geq Δα > 0.66 \% , Δα = 5 \times {10}^{- 5} \times \vert CT\_AV \vert + 0.0026 ;$$
a tensile stress linear density CT_LD is 45000 MPa/mm to 90000 MPa/mm;

|CT_CV| is 50 MPa to 210 MPa;
wherein:
CT_AV represents an average tensile stress in the tensile stress layer, measured in MPa;
CT_CV represents a maximum tensile stress in the tensile stress layer, measured in MPa; and
DOL_0 represents a depth of the compressive stress layer, measured in μm.

33. The strengthened glass-ceramic according to claim 32, wherein in the strengthened glass-ceramic: 1.01%≥Δα≥0.69%.

34. The strengthened glass-ceramic according to claim 32, wherein in the strengthened glass-ceramic:

|CT_AV| is greater than 80.63 MPa; and/or

|CT_CV| is greater than 113 MPa; and/or
$$DOL\_ 0 \geq 0.195 t .$$

35. The strengthened glass-ceramic according to claim 32, wherein in the strengthened glass-ceramic:
CS_50 is 100 MPa to 400 MPa; and/or
CS_100 is 20 MPa to 150 MPa;
wherein:
CS_50 represents a compressive stress at a depth of 50 μm from a glass surface, measured in MPa; and
CS_100 represents a compressive stress at a depth of 100 μm from the glass surface, measured in MPa.

36. The strengthened glass-ceramic according to claim 32, wherein in the strengthened glass-ceramic:

|CT_AV| is 85.49 MPa to 101.19 MPa; and/or

|CT_CV| is 113.54 MPa to 145.86 MPa.

37. The strengthened glass-ceramic according to claim 32, wherein in the strengthened glass-ceramic:
$$( CS\_ 50 / DOL\_ 0 ) \geq 0.332 \times ( surface CS / \vert CT\_CV \vert ) ;$$
wherein:
surface CS represents a surface compressive stress, measured in MPa.

38. The strengthened glass-ceramic according to claim 32, wherein the strengthened glass-ceramic has a total content of the petalite crystalline phase and the lithium disilicate crystalline phase of greater than or equal to 75 wt %; and/or
the strengthened glass-ceramic has an average grain size of 10 nm to 50 nm.

39. The strengthened glass-ceramic according to claim 32, wherein the tensile stress layer of the strengthened glass-ceramic comprises the following oxides by weight percentages:
65.00% to 75.00% of SiO₂, 5.00% to 10.00% of Al₂O₃, 1.00% to 5.00% of P₂O₅, 1.00% to 10.00% of ZrO₂, and 5.00% to 15.00% of Li₂O.

40. The strengthened glass-ceramic according to claim 32, wherein the strengthened glass-ceramic with a thickness of 0.7 mm is transparent and has a transmittance of not less than 90.00% for light at a wavelength of 550 nm; and/or
the strengthened glass-ceramic has an average sandpaper drop resistance height of between 1.30 m and 1.80 m when the strengthened glass-ceramic with a thickness of 0.7 mm is tested for sandpaper drop resistance with an 80-mesh sandpaper.

41. A strengthened glass-ceramic, comprising a petalite crystalline phase and a lithium disilicate crystalline phase, wherein the strengthened glass-ceramic has a compressive stress layer formed by chemical strengthening on a surface and a tensile stress layer inside; and
wherein, in the strengthened glass-ceramic:
DOL_0≥0.187 t, t is a thickness of the strengthened glass-ceramic;
$$1.01 \% \geq Δα \geq 0.65 \% , Δα = 5 \times {10}^{- 5} \times \vert CT\_AV \vert + 0.0026 ;$$
$$( CS\_ 50 / DOL\_ 0 ) \geq 0.332 \times ( surface CS / \vert CT\_CV \vert ) ;$$
wherein:
surface CS represents a surface compressive stress, measured in MPa;
CS_50 represents a compressive stress at a depth of 50 μm from a glass surface, measured in MPa;
CT_AV represents an average tensile stress in the tensile stress layer, measured in MPa;
CT_CV represents a maximum tensile stress in the tensile stress layer, measured in MPa; and
DOL_0 represents a depth of the compressive stress layer, measured in μm.

42. The strengthened glass-ceramic according to claim 41, wherein the tensile stress layer of the strengthened glass-ceramic comprises the following oxides by weight percentages:
SiO₂: 65.00% to 75.00%,
Al₂O₃: 5.00% to 10.00%,
P₂O₅: 1.00% to 5.00%,
CaO: 0.10% to 3.00%,
ZrO₂: 1.00% to 10.00%,
Na₂O: 0% to 5.00%,
Li₂O: 5.00% to 15.00%,
K₂O: 0.10% to 3.00%, and
B₂O₃: 0% to 4.00%.
